(19) United States
(12) Patent Application Publication
(10) Pub. No.: US 2013/0324220 A1
(43) Pub. Date: Dec. 5, 2013

(54) WAGERING GAME CONTENT BASED ON LOCATIONS OF PLAYER CHECK-IN

(71) Applicant: WMS GAMING, INC., Waukegan, IL (US)

(72) Inventors: Michael V. Dicillo, Norridge, IL (US); Dave Savage, Chicago, IL (US); Jamie W. Vann, Chicago, IL (US); Matthew J. Ward, Northbrook, IL (US)

(73) Assignee: WMS GAMING, INC., Waukegan, IL (US)

(21) Appl. No.: 13/786,128

(22) Filed: Mar. 5, 2013

Related U.S. Application Data
(60) Provisional application No. 61/655,328, filed on Jun. 4, 2012.

(51) Int. Cl. G07F 17/32

(52) U.S. Cl. CPC G07F 17/3244
USPC 463/25

(57) ABSTRACT

A computer-implemented method comprises replacing, by one or more processors, original wagering game content with modified wagering game content based on a wagering game player's check-ins at one or more physical locations. The method also includes presenting, on an electronic display device, a wagering game with the modified wagering game content in place of the original wagering game content.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2013, WMS Gaming, Inc.

### FIELD

Embodiments of the inventive subject matter relate generally to wagering game systems, and more particularly to wagering game systems including modified wagering game content based on locations of player check-in.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### BRIEF DESCRIPTION OF THE FIGURES

Embodiments of the invention are illustrated in the Figures of the accompanying drawings in which:

FIG. 1 depicts a system that provides modified wagering game content for wagering games based on physical locations where the wagering game player has checked-in, according to some embodiments.

FIG. 2 depicts a screenshot of a mobile application for a mobile device, according to some embodiments.

FIGS. 3-4 depict a mobile device executing a mobile application, according to some embodiments.

FIG. 5 depicts a screenshot of a wagering game for describing the check-in feature, according to some embodiments.

FIG. 6 depicts a screenshot of a base-game screen for a wagering game that includes modified wagering game content, according to some embodiments.

FIG. 7 depicts a screenshot of a screen of a wagering game for describing modified wagering game content, according to some embodiments.

FIG. 8 depicts a flowchart of operations for tracking physical locations where the wagering game player has checked in, according to some embodiments.

FIG. 9 depicts a flowchart of operations for including modified wagering game content for wagering games based on physical locations where the wagering game player has checked-in, according to some embodiments.

FIG. 10 depicts a block diagram illustrating a wagering game machine architecture, according to some embodiments.

FIG. 11 depicts a block diagram illustrating a wagering game network, according to some embodiments.

FIG. 12 depicts a perspective view of a wagering game machine, according to some embodiments.

FIG. 13 depicts an image of a base-game screen for a wagering game machine, according to some embodiments.

### DESCRIPTION OF THE EMBODIMENTS

This description of the embodiments is divided into six sections. The first section provides an introduction to some embodiments, while the second section provides a system environment. The third section describes example operations performed by some embodiments. The fourth section describes an example wagering game machine architecture and network environment. The fifth section describes an example wagering game machine and the sixth section presents some general comments.

### Introduction

This section provides an introduction to some embodiments. In some embodiments, wagering game content is modified based on physical locations where a wagering game player has checked-in. For example, the wagering game player can check-in at different physical locations (e.g., different retail stores) using a mobile application on their mobile device (e.g., mobile phone) before playing the wagering game.

These physical locations may or may not be associated with wagering game activity. For example, these physical locations can include coffee shops, restaurants, public parks, cities, various landmarks in a city, wagering game establishments, specific machines in wagering game establishments, etc. As part of a check-in process, the mobile device can transmit an identification of the wagering game player and the player's physical location to a remote server using, for example, wireless communications. Later, when the wagering game player is at a wagering game machine (or other device for playing a wagering game), wagering game content can be modified based on the physical locations that the player visited.

An example process for providing modified content to wagering game machines may work as follows. After the player has logged into the wagering game machine, the wagering game machine can transmit the player's identification to a wagering game server. In response, the remote server can provide, to the wagering game machine, physical locations that the player has visited. Additionally, the remote server can provide the modified wagering game content to the wagering game machine (if the modified wagering game content is not already stored in the wagering game machine).

The wagering game player can then play the wagering game based on the modified wagering game content. The modified wagering game content can affect aspects of the game's presentation (e.g., images, video, audio, etc.). For example, if the wagering game is a slots game, one or more of the reel symbols can be modified to represent the physical locations visited by the player. For example, the physical locations can be associated with a business entity, a government entity, a geographic location, etc. In such configurations, the modified wagering game content can be graphics or images that represent the associated business entity, government entity, geographic location, etc. Additionally, the modified wagering game content can affect play of the wagering game. For example, the expected value (EV) (i.e., the theoretical average payout) of the wagering game can be increased based on the modified wagering game content. To illustrate this for slots games, bonuses can be added, reel symbols can be changed from a non-wild symbol to a wild symbol, etc. As a result, the modified content can increase a wagering game's EV. In addition to slots games, other types of wagering games can include dice games, card games, spinning wheel games, etc. In some embodiments, the modified wagering game content can affect items other than the wagering game itself. For example, the modified wagering game content can include the graphics for the button panels, the background of the game, different animations in the main or secondary displays, etc. Some embodiments are applicable to both online wagering games (e.g., internet-based wagering game websites) and wagering games on wagering game machines at brick-and-mortar wagering game establishments. Additionally, the wagering games can be played online via a mobile device. For example, the mobile device that is used for checking-in can also be used for playing the online wagering games. Also, wagering can include wagering of real money, “fun” money, or anything else of real or perceived value on an event with an uncertain outcome.

### System Environment

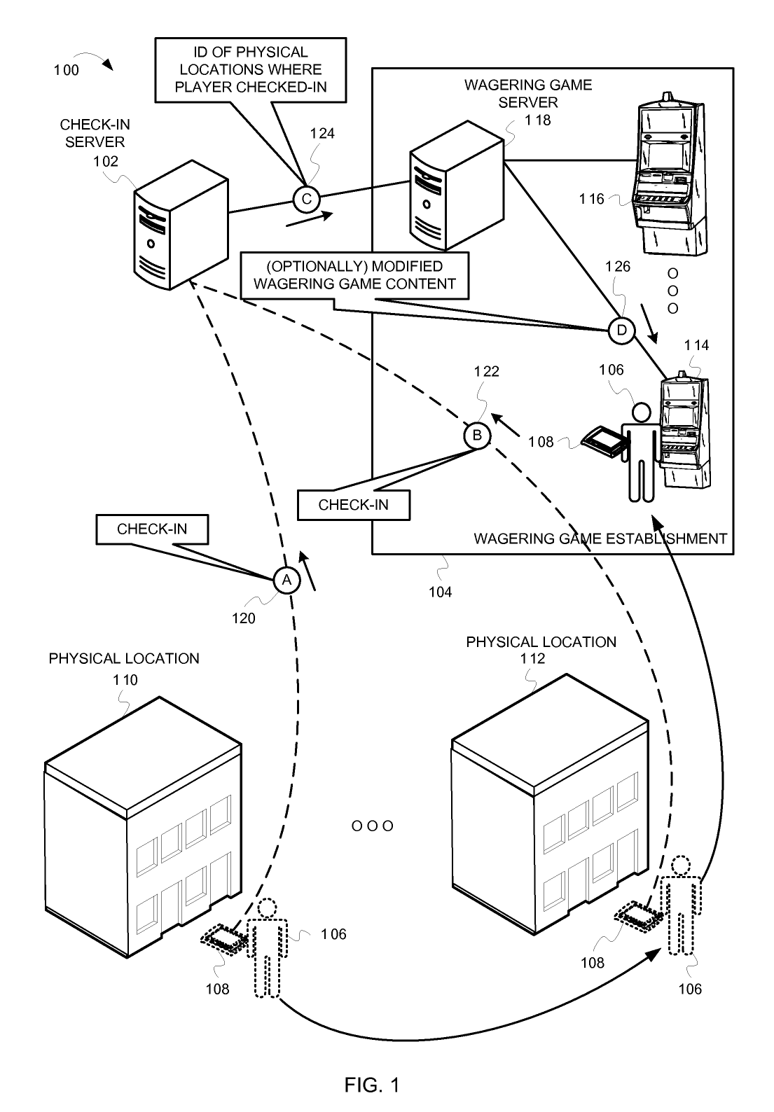

FIG. 1 depicts a system that provides modified wagering game content for wagering games based on physical locations where the wagering game player has checked-in, according to some embodiments. A system 100 can modify wagering game content based on physical locations where a wagering game player has checked-in. For example, the wagering game player can check-in at different physical locations (e.g., different retail stores) using a mobile application on their mobile devices prior to playing the wagering game.

FIG. 1 shows a wagering game establishment 104. The system 100 includes a check-in server 102, wagering game machines 114-116, and a wagering game server 188. These components are connected via a computer network. In FIG. 1, the wagering game machine 114 presents the wagering game in the wagering game establishment 104. However, the wagering game can be presented on any type of device (including devices outside wagering game establishments, as described above).

FIG. 1 also shows physical locations 110-112. While shown as buildings in FIG. 1, the physical locations can be any location where a wagering game player checks-in. For example, the physical locations can include coffee shops, restaurants, public parks, cities, various landmarks in a city, wagering game establishments, specific machines in wagering game establishments, etc. As shown in FIG. 1, a wagering game player 106 has a mobile device 108. Also in this example, the wagering game player 106 is shown moving to different physical locations and finally to the wagering game machine 114.

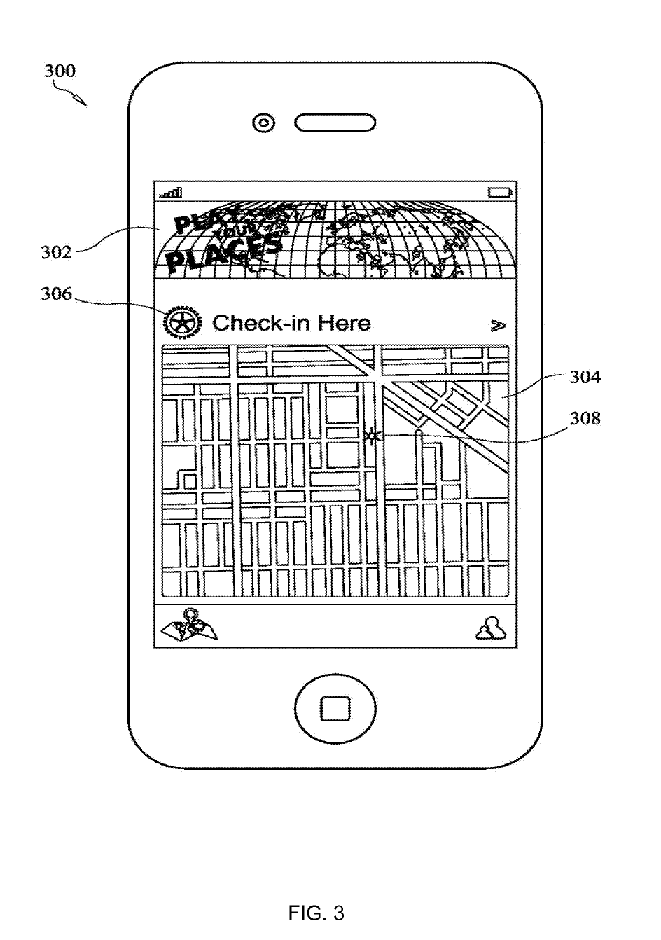

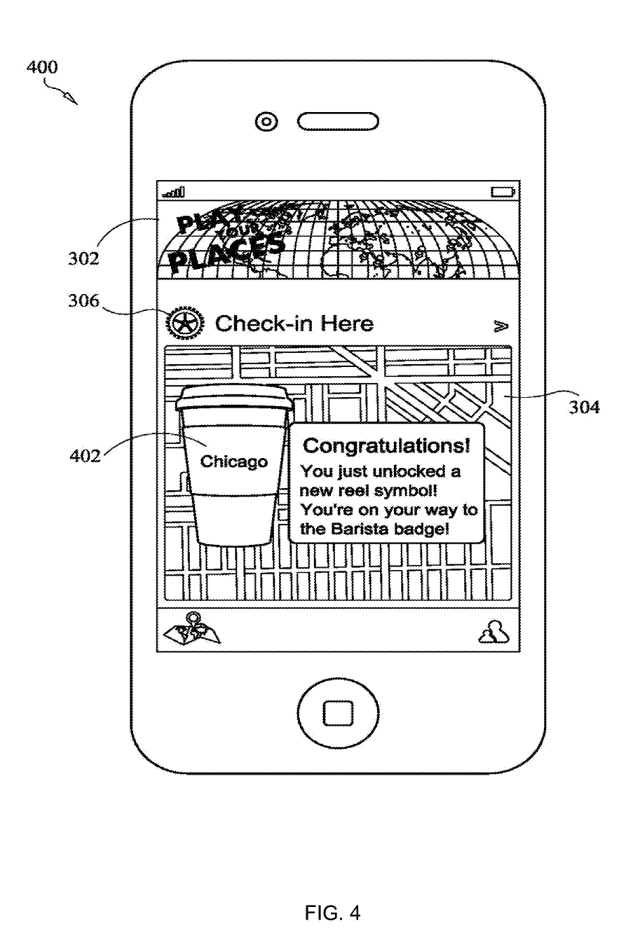

Initially, the wagering game player 106 is near the physical location 110. Also, the wagering game player 106 checks-in using an application on their mobile device 108. An example of such a mobile application on a mobile device is illustrated in FIGS. 3-4, which are described in more detail below. The mobile application can provide a list of physical locations near the wagering game player 106, based on the Global Positioning System (GPS) coordinates provided by the mobile device 108. The wagering game player 106 can then select a physical location (among a list of physical locations) for checking-in. In FIG. 1, the wagering game player 106 selects the physical location 110 from a list of physical locations displayed on the mobile device 108. In response to the selection, the mobile device 108 wirelessly transmits a check-in transmission 120 to the check-in server 102. The check-in transmission 120 can include the identification of the physical location 110 and the identification of the wagering game player 106.

After checking in at location 110, the wagering game player 106 moves near the physical location 112. Using the mobile application on the mobile device 108, the wagering game player 106 checks-in at the physical location 112. The wagering game player 106 selects the physical location 112 from a list of physical locations displayed on the mobile device 108. In response to the selection, the mobile device 108 wirelessly transmits a check-in transmission 122 to the check-in server 102. The check-in transmission 122 can include the identification of the physical location 112 and the identification of the wagering game player 106. While FIG. 1 shows the player 106 checking-in at two physical locations, the player can check-in at any number of physical locations, and can also check-in at the same physical location multiple times.

After receiving the physical locations and player identification, the check-in server 102 transmits this data to the wagering game server 118—shown as a transmission 124. In some embodiments, the check-in server 102 can provide this data periodically and/or upon demand by the wagering game server 118. For example, the wagering game server 118 can request this data for a particular wagering game player after the player has logged into a wagering game machine at the wagering game establishment 104.

As shown, the wagering game player 106 next moves to play the wagering game machine 114. The wagering game player 106 may log into a player account at the wagering game machine 114. The system can modify wagering game content used for presenting a wagering game on the wagering game machine 114 based on player's identification and physical locations where the player checked-in. In some embodiments, the wagering game server 118 can transmit the modified wagering game content to the wagering game machine 114. Alternatively, the wagering game module in the wagering game machine 114 can retrieve the modified wagering game content from local machine-readable media therein.

The modified wagering game content can affect different aspects of the presentation layer (e.g., images, video, audio, etc.). For example, if the wagering game is a slots game, one or more of the reel symbols can be modified to represent the physical locations visited by the player. For example, the physical locations can be associated with a business entity, a government entity, a geographic location, etc. In such configurations, the modified wagering game content can be graphics or images that represent the associated business entity, government entity, geographic location, etc. Additionally, the modified wagering game content can affect play of the wagering game. For example, the expected value of the wagering game can be increased based on the modified wagering game content. For slots games, bonuses can be added, reel symbols can be changed from a non-wild symbol to a wild symbol, etc.

In some embodiments, one or more check-ins at a particular physical location can trigger, in the wagering game, a bonus associated with that location. For example, after the player has checked-in ten times at a coffee shop, the wagering game presents a bonus game having content associated with the coffee shop. The new bonus game can be configured to affect or not affect the existing overall expected value (EV) of the wagering game. For example, this new bonus can replace an existing bonus in the wagering game and have the same EV as the existing bonus, thereby not affecting the overall EV of the wagering game. Alternatively, this new bonus and its associated EV can be added to the wagering game, thereby increasing the overall EV.

In some embodiments, an entity associated with a physical location can be a sponsor of modified wagering game content (e.g., a bonus). That is, the sponsor may provide value to wagering game providers (e.g. casinos) to pay for increases in EV (if any), and for the gaming content that promotes the sponsor's physical location (e.g. a retail store). In return, the sponsor receives the advertising value associated with the modified wagering game content. For example, the sponsor's corporate logo, product graphics, etc. may be added to the wagering game to promote the sponsor. In some embodiments, as part of a sponsored bonus, the sponsor can provide a non-cash award, such as a coupon. For example, the coupons can provide free or discounted items at a particular coffee shop. This award can be in lieu of or in addition to a monetary result for a bonus game.

In some embodiments, the amount of modified wagering game content added to a wagering game is based on the number of check-ins by a player at a particular physical location. For example, in a slot game, a reel symbol is replaced for each time a player checks-in at a location. The replacement symbols can include images associated with the location, sponsor, etc. Also, there can be a maximum number of these reel symbols that are replaced. For example, a maximum of one symbol per reel can be modified to represent the physical location. Therefore, if there are five reels, a maximum of five reel symbols can be modified (one for each reel) to represent the physical location, in response to five different check-ins by the player at the location.

In some embodiments, a mobile device is not required for check-in at a physical location. For example, a player loyalty program can provide player account login information at different locations (e.g., different wagering game machines at wagering game establishments). Also, the player's physical location can be determined based on the network address (e.g., Media Access Control (MAC) address) of the wagering game machine where the player is logged in. The network address can be cross-referenced with a database of network addresses for the different wagering game machines. This cross-reference can determine the player's location. To illustrate, a player check-in is considered complete after the player logs into their player account and wagers at a wagering game machine. These check-ins at different wagering game machines can then provide for modified wagering game content for a wagering game (at these machines or other wagering game machines).

In some embodiments, the wagering game is a slots game. For a slots game, a pay table defines a hierarchy of payouts for winning combinations of the reel symbols (from low to high). For example, a winning combination of matching cherry reel symbols would be a lowest payout; a winning combination of matching orange reel symbols would be a second lowest payout; a winning combination of matching 7's would be a higher payout, etc. In some embodiments, the number of player check-ins to a physical location modifies the symbol hierarchy for the reel symbols in the slots game. This modification can be through replacement or watermarking of an existing reel symbol. To illustrate, if the player has checked-in at the physical location 112 in a range of 1 to 5 times, the reel symbol having the lowest payout in the symbol hierarchy is replaced or watermarked with images representing the physical location 112. If the player has checked-in at the physical location 112 in a range of 6 to 20 times, the reel symbol having the second lowest payout in the symbol hierarchy is replaced or watermarked with images representing the physical location 112. If the player has checked-in at the physical location 112 in a range of 21 to 50 times, the reel symbol having the third lowest payout in the symbol hierarchy is replaced or watermarked with images representing the physical location 112. This progression can continue to the top of the symbol hierarchy. At the top of the hierarchy, the winning combination based on reel symbols representing the physical location 112 can trigger a bonus game in the wagering game. An existing bonus game is replaced by a bonus game representing the physical location 112 (e.g., different indicia presenting the physical location 112, payouts defined relative to gift cards, coupons, etc. for the physical location 112, etc.). These ranges of check-ins can be defined to enable the replacement or watermarking of the different reel symbols within the hierarchy. As described above, in some embodiments, if the player achieves a winning combination of reel symbols representing the physical location or wins in the bonus game representing the physical location, the player can win prizes (e.g., coupons for the business entity). These prizes can be in lieu of or in addition to the traditional monetary payout associated with the reel symbol that was replaced.

Players may have checked-in at different physical locations (e.g., locations for two different business entities) that can modify the wagering game content. In some embodiments, the player can select which of the multiple physical locations are to be represented in the wagering game based on the modified wagering game content. In such embodiments, check-ins at only one but not both physical locations modify the wagering game content. However in some other example embodiments, check-ins at any number of different physical locations modify the wagering game content.

In some embodiments, the wagering game player may be required to check-in at multiple physical locations to access particular modified wagering game content. For example, the wagering game player may be required to check-in at the top 10 landmarks for a city to access modified wagering game content related to the city (e.g., a reel symbol that represents the city). In some embodiments, repeated check-ins at the same physical location enable the wagering game player to receive a leadership badge for that location (e.g., mayorship, governorship, presidencies, etc.). The modified wagering game content can relate to this leadership. For example, the modified wagering game content can include a reel symbol that includes an image indicative of the leadership earned.

In some embodiments, as the number of check-ins for a particular physical location varies (e.g., increases) the modified wagering game content also varies. For example, assume that the modified wagering game content includes a reel symbol. If the number of check-ins exceeds a defined value, the reel symbol is converted into a wild symbol or into a symbol that covers multiple spots on the reel.

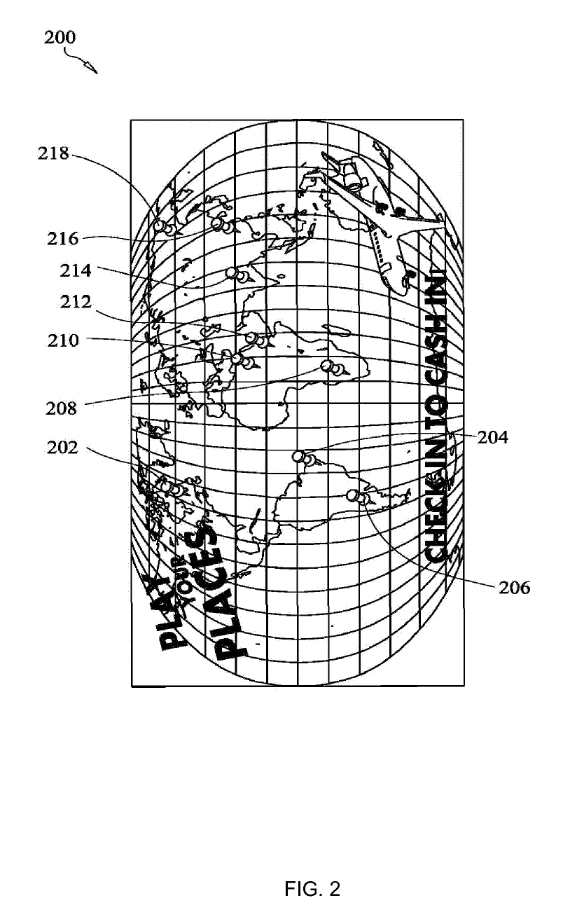

FIG. 2 depicts a screenshot of a mobile application for a mobile device, according to some embodiments. FIG. 2 depicts a screenshot 200 that can be presented on a mobile device's display device after a wagering game player initiates the mobile application. The screenshot 200 includes a global map with a number of push pins (push pins 202-218). In some embodiments, instead of a global map, the map can be a regional map (e.g., map of the United States) that provides a Graphical User Interface (GUI) indicating where the wagering game player has actually checked-in. Accordingly, the push pins 202-218 can represent the physical locations where the wagering game player has checked in.

FIGS. 3-4 depict a mobile device executing a mobile application, according to some embodiments. FIG. 3 depicts a mobile device 300 with a screen displaying a mobile application prior to a check-in by the wagering game player. FIG. 4 depicts the mobile device 300 after the check-in.

The mobile device 300 includes a screen 302 for displaying a visual output for the mobile application used for player check-in (as described above). The display of the mobile application includes a map 304 to enable the wagering game player to see where they are currently located. The map 304 displays a current location 308 of the mobile device 300. The display of the mobile application also includes a check-in button 306. After the wagering game player has arrived at a physical location on the map 304 where they want to check-in, they can select the check-in button 306. In response, the mobile application can provide a list of possible physical locations relative to the current GPS coordinates for the mobile device 300 (as described above). The wagering game player can select a physical location for checking-in based on the list.

FIG. 4 depicts the mobile device 300 after the wagering game player has selected the physical location for checking-in. In response, a graphic 402 is overlaid on the map 304 that notifies the wagering game player that they have unlocked a new reel symbol for a wagering game based on their check-in. In this example as shown by the graphic 402, the physical location is a coffee shop in Chicago. The graphic 402 also notifies the wagering game player that they are progressing to achieving a “Barista badge” for the coffee shop based on repeated check-ins.

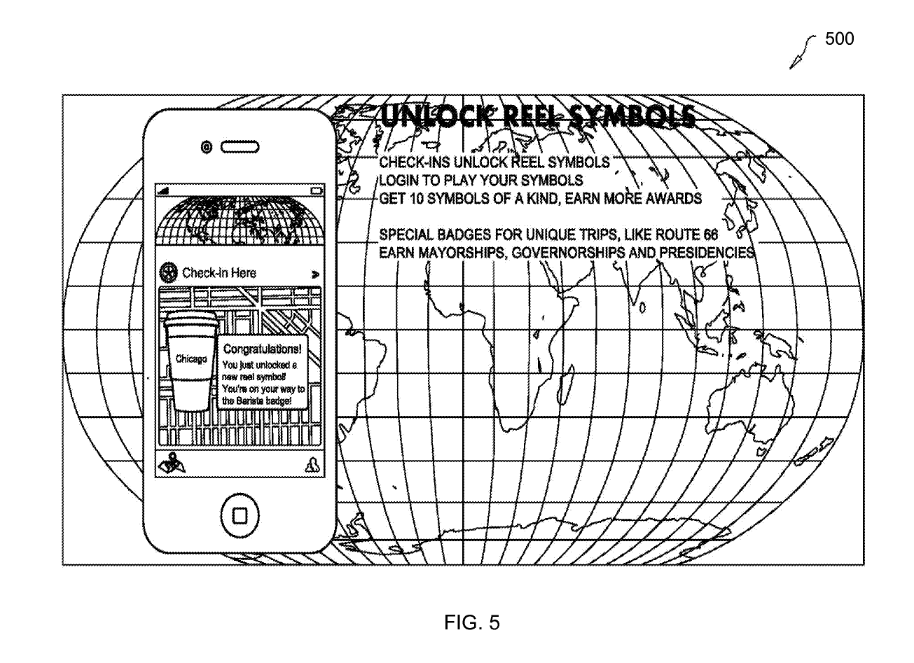

FIG. 5 depicts a screenshot of a wagering game for describing the check-in feature, according to some embodiments. A screenshot 500 is displayed to notify the wagering game player of the ability to modify the wagering game content for the wagering game and some advantages of doing so. In particular, the screenshot 500 notifies the wagering game player that check-ins unlock new reel symbols and the wagering game players are required to login to their player account at the wagering game to play these symbols. The screenshot 500 also displays a notification that the wagering game player can earn more awards by getting 10 symbols of a kind The screenshot 500 displays a notification that the wagering game player can earn special badges as part of checking-in at multiple locations for unique trips (e.g., Route 66). The screenshot 500 also displays a notification that the wagering game player can earn mayorships, governorships, and presidencies for a physical location based on repeated check-ins at the physical location. Also, as noted above, the modified wagering game content can include these special badges for unique trips, mayorships, governorships, and presidencies.

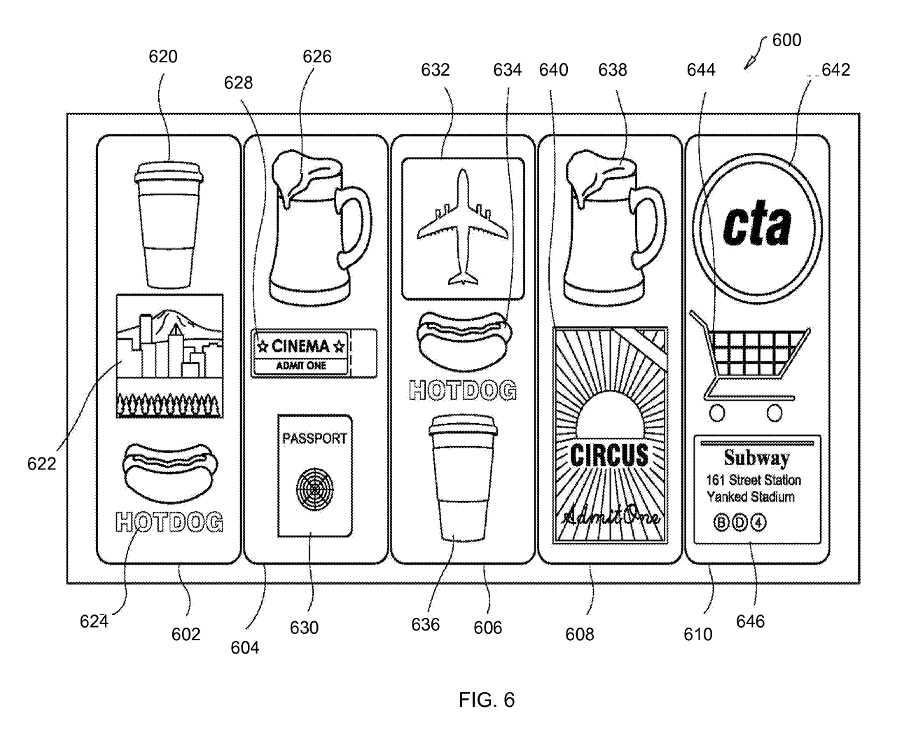

FIG. 6 depicts a screenshot of a base-game screen for a wagering game that includes modified wagering game content, according to some embodiments. A screenshot 600 includes a number of reel symbols that are examples of modified wagering game content. The screenshot 600 displays five different reels (reels 602-610). The reel 602 displays reel symbols 620-624. The reel 604 displays reel symbols 626-630. The reel 606 displays reel symbols 632-636. The reel 608 displays reel symbols 638-640. The reel 610 displays reel symbols 642-646. The reel symbols 620-646 represent different physical locations (including business entities, government entities, cites, etc.). In this example, all of the reel symbols shown include modified wagering game content for different physical locations. As described above, one to any number of physical locations can be represented by modified wagering game content based on player check-in. Also in some embodiments, not all of the reel symbols are replaced as modified wagering game content. Rather, only a portion of the reel symbols are new such that the new reel symbols are integrated with existing reel symbols on the reels.

The reel symbols 620 and 638 include a display of a coffee cup that represents a coffee shop. The reel symbol 622 includes a display of a graphic that represents the city of Seattle, Wash. The reel symbols 624 and 634 include a display of a hot dog that represents a restaurant that serves hot dogs. The reel symbols 626 and 638 include a display of a beer mug that represents a bar serving alcohol. The reel symbol 628 includes a display of a movie ticket that represents a movie theatre. The reel symbol 630 includes a display of a passport that represents that the wagering game player checked-in at a number of physical locations. For example, the passport can represent that the wagering game player has checked in at five different landmarks in Europe. The reel symbol 632 includes a display of an airplane that represents an airline terminal. The reel symbol 640 includes a display of a graphic for a ticket for admission to a circus that represents a circus. Of particularly note, the reel symbol 640 occupies two different reel locations for the reel 608. The wagering game player can unlock such a symbol based on multiple visits to this same physical location (as described above). The reel symbol 642 includes a display of a graphic for the Chicago Transit Authority (CTA). This reel symbol can represent that the wagering game player has checked at least N (e.g., 20) different times at different CTA locations. The reel symbol 644 includes a display of a grocery cart that presents a grocery store. The reel symbol 646 includes a display of a graphic for a particular subway stop near Yankee stadium that represents that particular subway stop.

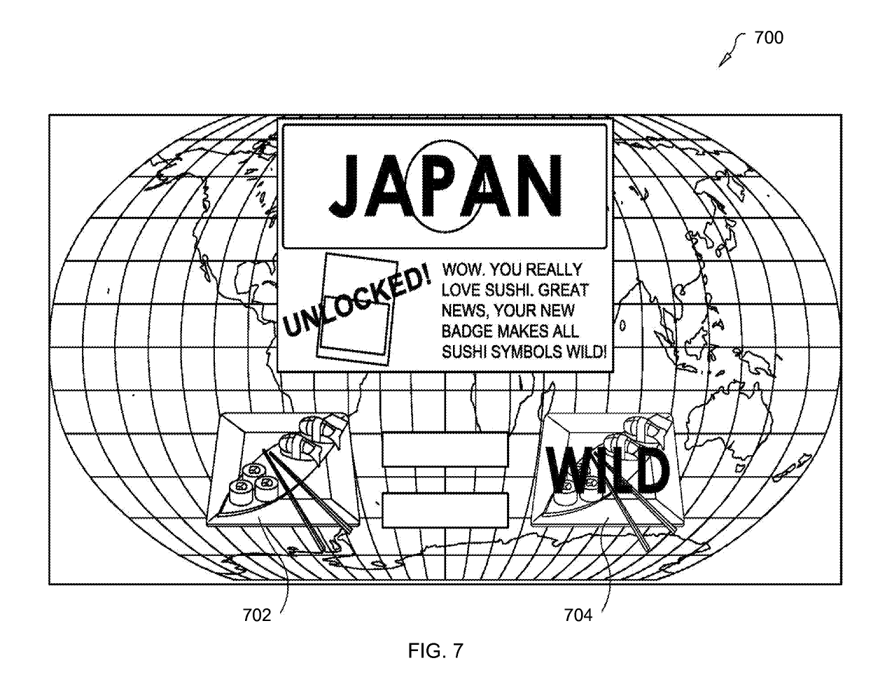

FIG. 7 depicts a screenshot of a screen of a wagering game for describing modified wagering game content, according to some embodiments. A screenshot 700 is displayed at the wagering game to notify the wagering game player that a reel symbol has been converted from a non-wild reel symbol (reel symbol 702) to a wild reel symbol (reel symbol 704). As shown, the reel symbols 702-704 represent a sushi restaurant. In this example, the wagering game player can obtain the reel symbol 702 after a check-in at the sushi restaurant. After the wagering game player has checked-in at sushi restaurant more than X (e.g., 10) number of times, the reel symbol 702 is changed to the reel symbol 704 (non-wild to wild). This screenshot 700 can be shown at the wagering game after the wagering game player has logged in.

### Example Operations

This section describes operations associated with some embodiments. In the discussion below, the flowcharts will be described with reference to the block diagrams presented above. However, in some embodiments, the operations can be performed by logic not described in the block diagrams.

In certain embodiments, the operations can be performed by executing instructions residing on machine-readable storage device, while in other embodiments, the operations can be performed by hardware and/or other logic (e.g., firmware). In some embodiments, the operations can be performed in series, while in other embodiments, one or more of the operations can be performed in parallel. Moreover, some embodiments can perform less than all the operations shown in any flowchart.

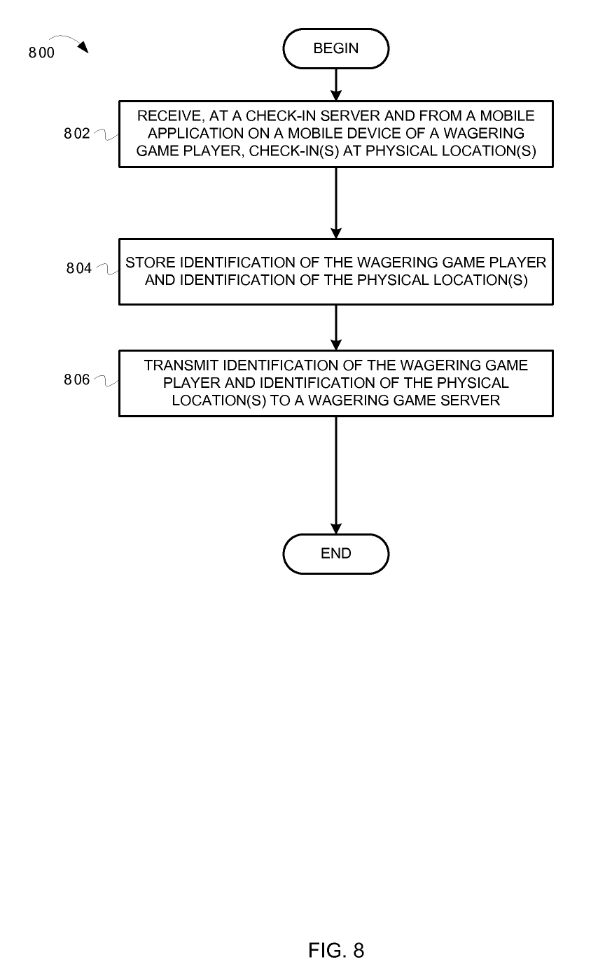

FIG. 8 depicts a flowchart of operations for tracking physical locations where the wagering game player has checked in, according to some embodiments. The operations of a flowchart 800 are described in reference to FIG. 1. In this example, the operations of the flowchart 800 are performed by the check-in server 102. The operations of the flowchart 800 begin at block 802.

At block 802, a check-in server receives, from a mobile application on a mobile device of a wagering game player, check-in(s) at physical location(s). With reference to FIG. 1, the check-in server 102 receives the check-in transmissions 120-122 from the mobile device 108 of the wagering game player 106, in response to the wagering game player 106 checking-in at the physical locations 110-112. Operations of the flowchart 800 continue at block 804.

At block 804, the check-in server stores the identification of the wagering game player and identification of the physical location(s). With reference to FIG. 1, the check-in server 102 can store this data in machine-readable storage media therein. Operations of the flowchart 800 continue at block 806.

At block 806, the check-in server transmits the identification of the wagering game player and identification of the physical location(s) to a wagering game server. With reference to FIG. 1, the check-in server 102 can transmit this data to the wagering game server 118. In some embodiments, the check-in server 102 can provide this data periodically and/or upon demand by the wagering game server 118. For example, the wagering game server 118 can request this data for a particular wagering game player after the player has logged into a wagering game machine at the wagering game establishment 104. Operations of the flowchart 800 are complete.

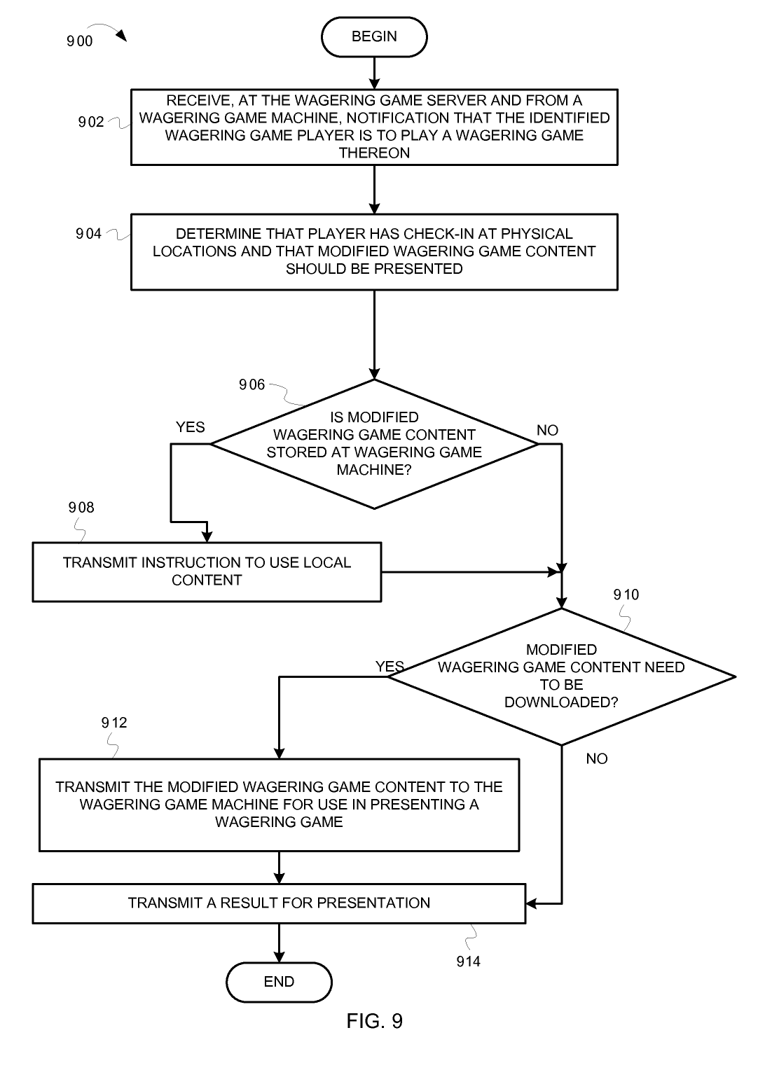

FIG. 9 depicts a flowchart of operations for including modified wagering game content for wagering games based on physical locations where the wagering game player has checked-in, according to some embodiments. The operations of a flowchart 900 are described in reference to FIG. 1. In this example, the operations of the flowchart 900 are performed by the wagering game server 118. The operations of the flowchart 900 begin at block 902.

At block 902, the wagering game server receives, from a wagering game machine, notification that the identified wagering game player is to play a wagering game thereon. With reference to FIG. 1, the wagering game player 106 provides some type of identification of themselves. For example, the wagering game player 106 can provide their identification by logging into their player account at the wagering game machine 114. In response, the wagering game machine 114 can transmit notification of the identification of the wagering game player 106 to the wagering game server 118. Operations of the flowchart 900 continue at block 904.

At block 904, the wagering game server determines that the wagering game player has checked-in at one or more physical locations and that modified wagering game content should be presented at the wagering game machine based on the check-ins. For example, check-ins at only some physical locations can modify wagering game content. Accordingly, the wagering game server 118 determines whether the recorded check-ins for the wagering game player allow for modification of the wagering game content. Also, there can be an option of whether to replace the original wagering game content with modified wagering game content. For example, the wagering game player can be given the option to replace the original wagering game content with modified wagering game content. Operations of the flowchart 900 continue at block 906.

At block 906, a determination is made of whether the modified wagering game content is stored at the wagering game machine. For example, some or all of the modified wagering game content (e.g., replacement images for reel symbols, replacement bonus games, etc.) for the identified physical locations can be stored in machine-readable storage media in the wagering game machine 114. The wagering game server 118 can make this determination. If there is any modified wagering game content (for the identified physical location(s) stored at the wagering game machine, operations of the flowchart 900 continue at block 908. Otherwise, operations of the flowchart 900 continue at block 910.

At block 908, the wagering game server transmits an instruction to the wagering game machine to use the modified wagering game content that is stored locally in a media in the wagering game machine. With reference to FIG. 1, the wagering game server 118 transmits this instruction to the wagering game machine 114. Operations of the flowchart 900 continue at block 910.

At block 910, a determination is made (for the identified physical location(s)) of whether any modified wagering game content needs to be downloaded. The wagering game server 118 can make this determination. In particular in some embodiments, modified wagering game content is transmitted from the wagering game server 118 if the modified wagering game content is not stored in machine-readable storage media in the wagering game machine 114. If any modified wagering game content needs to be transmitted from the wagering game server, operations of the flowchart 900 continue at block 912. Otherwise, operations of the flowchart 900 continue at block 914.

At block 912, the wagering game server transmits to the wagering game machine the modified wagering game content that needed to be provided. With reference to FIG. 1, the wagering game server 118 transmits the modified wagering game content to the wagering game machine 114—see the transmission 126. Accordingly as described, some or all of the modified wagering game content is transmitted from the wagering game server 118 (depending on what is stored in machine-readable storage media in the wagering game machine 114). Operations of the flowchart 900 continue at block 914.

At block 914, the wagering game server transmits a result for presentation of the wagering game. For example, the wagering game server can provide the random result for a slots game. Also, the wagering game machine can present the wagering game based on the modified wagering game content. Operations of the flowchart 900 are complete.

### Wagering Game Machine Architecture and Network Environment

This section describes an example wagering game architecture and network environment of some embodiments.

### Wagering Game Machine Architecture

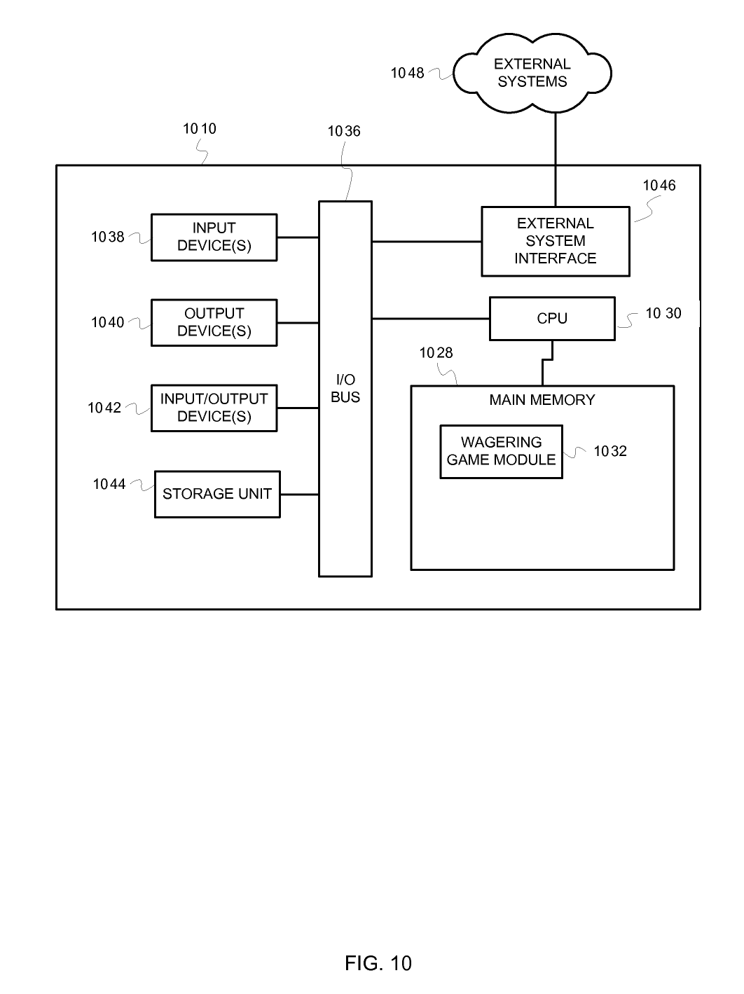

FIG. 10 depicts a block diagram illustrating a wagering game machine architecture, according to some embodiments. The gaming terminal 1010 includes a central processing unit (CPU) 1030 connected to a main memory 1032. The CPU 1030 may include any suitable processor(s), such as those made by Intel and AMD. By way of example, the CPU 1030 includes a plurality of microprocessors including a master processor, a slave processor, and a secondary or parallel processor. CPU 1030, as used herein, comprises any combination of hardware, software, or firmware disposed in or outside of the gaming terminal 1010 that is configured to communicate with or control the transfer of data between the gaming terminal 1010 and a bus, another computer, processor, device, service, or network. The CPU 1030 comprises one or more controllers or processors and such one or more controllers or processors need not be disposed proximal to one another and may be located in different devices or in different locations. The CPU 1030 is operable to execute all of the various gaming methods and other processes disclosed herein. The main memory 1028 includes a wagering game module 1032. In one embodiment, the wagering game module 1032 may present wagering games, such as video poker, video black jack, video slots, video lottery, etc., in whole or part. In some embodiments, the wagering game module performs operations for presenting wagering games based on modified wagering game content (as described above).

The CPU 1030 is also connected to an input/output (I/O) bus 1036, which can include any suitable bus technologies, such as an AGTL+frontside bus and a PCI backside bus. The I/O bus 1036 is connected to various input devices 1038, output devices 1040, and input/output devices 1042. The I/O bus 1036 is also connected to storage unit 1044 and external system interface 1046, which is connected to external system(s) 1048 (e.g., wagering game networks).

The external system 1048 includes, in various aspects, a gaming network, other gaming terminals, a gaming server, a remote controller, communications hardware, or a variety of other interfaced systems or components, in any combination. In yet other aspects, the external system 1048 may comprise a player's portable electronic device (e.g., cellular phone, electronic wallet, etc.) and the external system interface 1046 is configured to facilitate wireless communication and data transfer between the portable electronic device and the CPU 1030, such as by a near-field communication path operating via magnetic-field induction or a frequency-hopping spread spectrum RF signals (e.g., Bluetooth, etc.).

The gaming terminal 1010 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 1048 (“thin client” gaming terminal), or are distributed therebetween in any suitable manner (“intermediate client” gaming terminal).

Any component of the gaming terminal architecture may include hardware, firmware, or tangible machine-readable storage devices including instructions for performing the operations described herein. Machine-readable storage devices include any mechanism that stores information and provides the information in a form readable by a machine (e.g., gaming terminal, computer, etc.). For example, machine-readable storage devices include semiconductor read only memory (ROM), semiconductor random access memory (RAM), magnetic disk storage media, optical storage media, flash memory, etc.

### Wagering Game Network

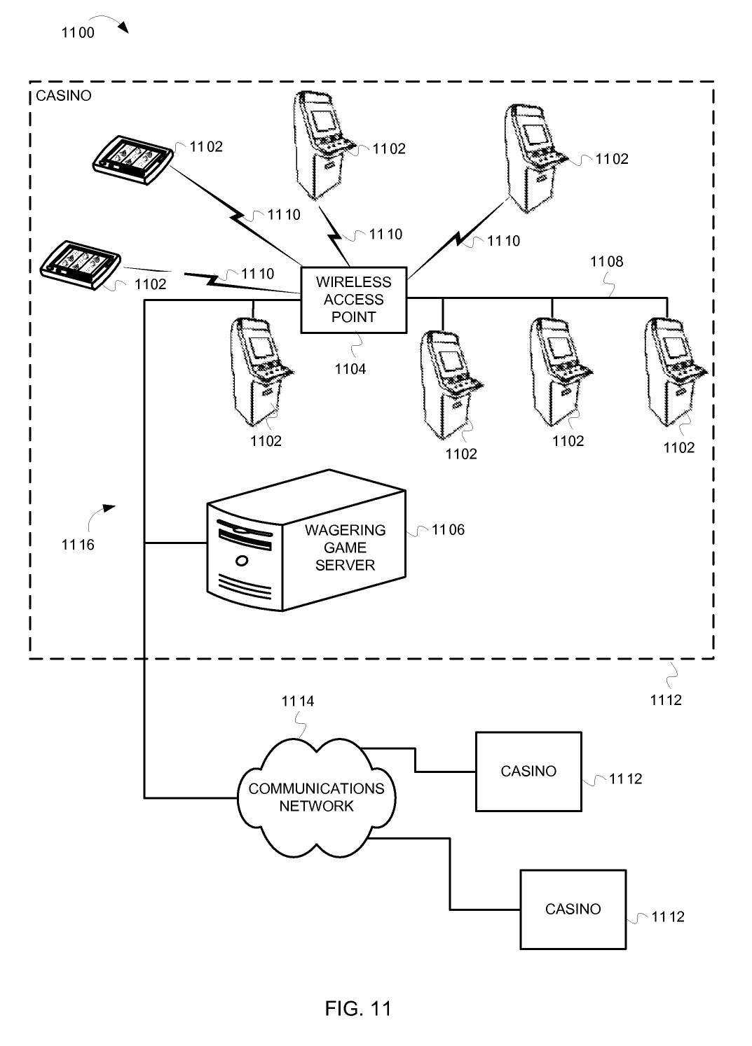

FIG. 11 depicts a block diagram illustrating a wagering game network, according to some embodiments. As shown in FIG. 11, the wagering game network 1100 includes a plurality of casinos 1112 connected to a communications network 1114.

Each casino 1112 includes a local area network 1116, which includes an access point 1104, a wagering game server 1106, and wagering game machines 1102. The access point 1104 provides wireless communication links 1110 and wired communication links 1108. The wired and wireless communication links can employ any suitable connection technology, such as Bluetooth, 802.11, Ethernet, public switched telephone networks, SONET, etc. In some embodiments, the wagering game server 1106 can serve wagering games and distribute content to devices located in other casinos 1112 or at other locations on the communications network 1114.

The wagering game machines 1102 described herein can take any suitable form, such as floor standing models, handheld mobile units, bartop models, workstation-type console models, etc. Further, the wagering game machines 1102 can be primarily dedicated for use in conducting wagering games, or can include non-dedicated devices, such as mobile phones, personal digital assistants, personal computers, etc. In one embodiment, the wagering game network 1100 can include other network devices, such as accounting servers, wide area progressive servers, player tracking servers, and/or other devices suitable for use in connection with embodiments of the invention.

In some embodiments, wagering game machines 1102 and wagering game servers 1106 work together such that a wagering game machine 1102 can be operated as a thin, thick, or intermediate client. For example, one or more elements of game play may be controlled by the wagering game machine 1102 (client) or the wagering game server 1106 (server). Game play elements can include executable game code, lookup tables, configuration files, game outcome, audio or visual representations of the game, game assets or the like. In a thin-client example, the wagering game server 1106 can perform functions such as determining game outcome or managing assets, while the wagering game machine 1102 can present a graphical representation of such outcome or asset modification to the user (e.g., player). In a thick-client example, the wagering game machines 1102 can determine game outcomes and communicate the outcomes to the wagering game server 1106 for recording or managing a player's account. In some embodiments, the wagering game machines 1102 can have handheld devices and can be part of communal event (as described above).

In some embodiments, either the wagering game machines 1102 (client) or the wagering game server 1106 can provide functionality that is not directly related to game play. For example, account transactions and account rules may be managed centrally (e.g., by the wagering game server 1106) or locally (e.g., by the wagering game machine 1102). Other functionality not directly related to game play may include power management, presentation of advertising, software or firmware updates, system quality or security checks, etc.

In some embodiments, the wagering game server 1106 can host online wagering games, such as by hosting one or more online wagering game websites. Players can sign-on to such websites and play wagering games via web browsers, client applications, etc. In some embodiments, online gaming functionality is performed by an online gaming server (not shown), where the online gaming server does not determine results for the wagering game machines 1102.

Any of the wagering game network components (e.g., the wagering game machines 1102) can include hardware and machine-readable media including instructions for performing the operations described herein.

### Example Wagering Game Machine

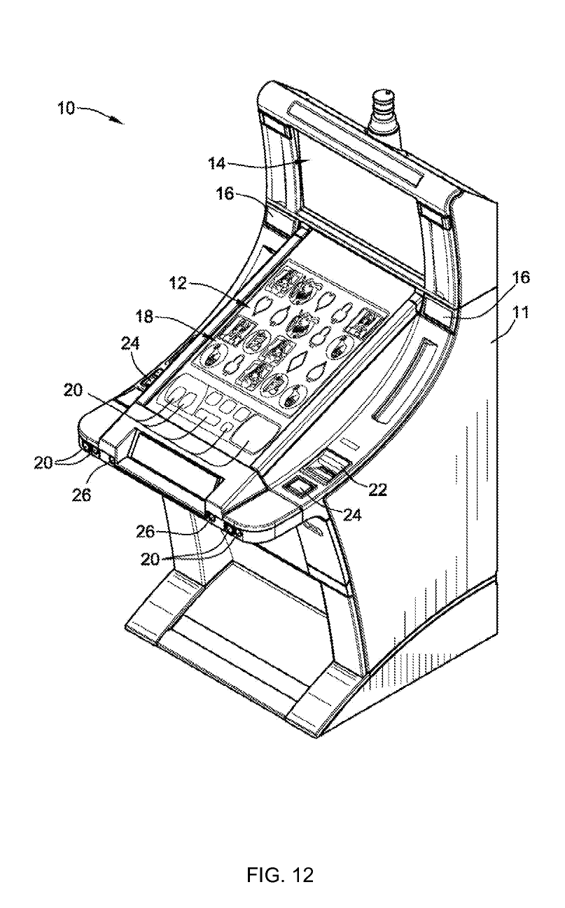

FIG. 12 depicts a perspective view of a wagering game machine, according to some embodiments. Referring to FIG. 12, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0062196 and US2010/0234099, which are incorporated herein by reference in their entireties.

The gaming terminal 10 illustrated in FIG. 12 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

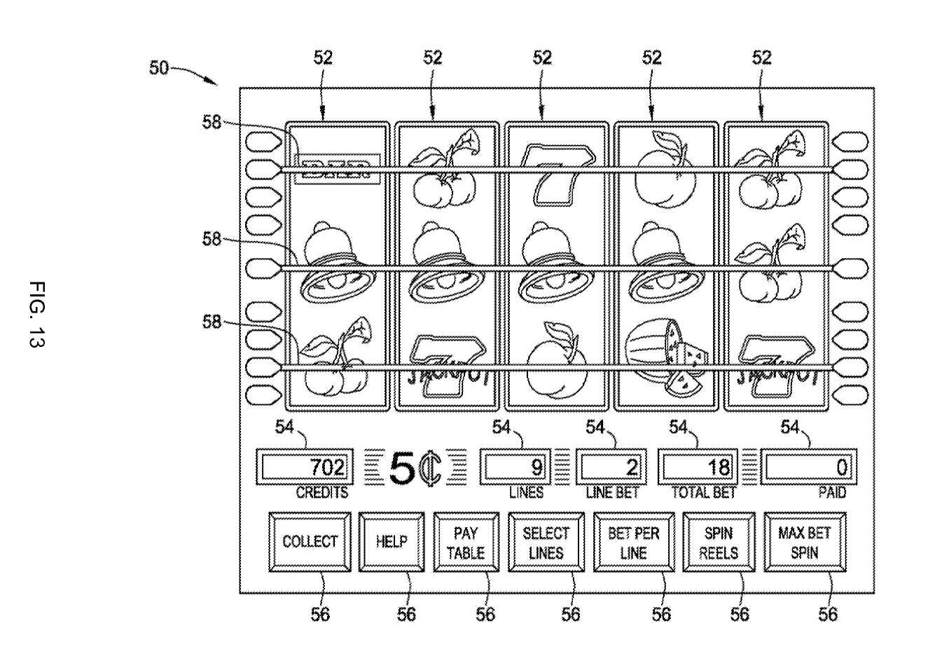

FIG. 13 depicts an image of a base-game screen for a wagering game machine, according to some embodiments. Referring to FIG. 13, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 12. The CPU operate(s) to execute a wagering game program causing the primary display area 12 or the secondary display area 14 to display the wagering game.

In response to receiving a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 1030) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 1044), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claims. Each of the embodiments described herein are contemplated as falling within the inventive subject matter, which is set forth in the following claims.

1. A computer-implemented method comprising:
replacing, by one or more processors, original wagering game content with modified wagering game content based on a wagering game player's check-ins at one or more physical locations; and
presenting, on an electronic display device, a wagering game with the modified wagering game content in place of the original wagering game content.

2. The computer-implemented method of claim 1, wherein the modified wagering game content indicates the one or more physical locations.

3. The computer-implemented method of claim 1, further comprising:
receiving, over a computer network, the modified wagering game content at a wagering game machine including the electronic display device.

4. The computer-implemented method of claim 1, wherein the physical location is associated with a business entity, and wherein a portion of the modified wagering game content is sponsored by the business entity.

5. The computer-implemented method of claim 4, wherein the portion of the modified wagering game content comprises a game result that includes an award of monetary value provided by the business entity.

6. The computer-implemented method of claim 1, wherein the modified wagering game content varies based on a number of player check-ins at the one or more physical locations.

7. The computer-implemented method of claim 1, wherein prior to the replacing, presenting, on the electronic display device, the wagering game with the original wagering game content.

8. A computer-implemented method comprising:
replacing, by one or more processors, original wagering game content with modified wagering game content based on a wagering game player's check-in at a physical location, the physical location being associated with a business entity, the modified wagering game content being representative of and sponsored by the business entity; and
presenting, on an electronic display device, a wagering game with the modified wagering game content in place of the original wagering game content.

9. The computer-implemented method of claim 8, wherein presenting the wagering game comprises outputting a result of the wagering game, wherein the result includes an award of monetary value provided by the business entity.

10. The computer-implemented method of claim 8, wherein the wagering game comprises a slots game having reel symbols, wherein modifying the wagering game content comprises replacing at least one of the reel symbols with a modified reel symbol.

11. The computer-implemented method of claim 10, wherein replacing the at least one of the reel symbols with the modified reel symbol comprises:
replacing a first one of the reel symbols associated with a first payout value in response to a first number of check-ins by the wagering game player at the physical location; and
replacing a second one of the reel symbols associated with a second payout value that is higher than the first payout value in response to a second number of check-ins by the wagering game player at the physical location, the second number of check-ins being greater than the first number of check-ins.

12. The computer-implemented method of claim 8, wherein prior to the replacing, presenting, on the electronic display device, the wagering game with the original wagering game content.

13. An apparatus comprising:
at least one display device;
at least one processor;
at least one memory device configured to store instructions that, when executed by the at least one processor, cause the apparatus to:
replace original wagering game content with modified wagering game content based on a wagering game player's check-ins at one or more physical locations; and
present, on the at least one display device, a wagering game with the modified wagering game content in place of the original wagering game content.

14. The apparatus of claim 13, wherein the modified wagering game content indicates the one or more physical locations.

15. The apparatus of claim 13, wherein the instructions further cause the apparatus to receive, over a computer network, the modified wagering game content.

16. The apparatus of claim 13, wherein the physical location is associated with a business entity, and wherein a portion of the modified wagering game content is sponsored by the business entity.

17. The apparatus of claim 16, wherein the portion of the modified wagering game content comprises a game result that includes an award of monetary value provided by the business entity.

18. The apparatus of claim 13, wherein the modified wagering game content varies based on a number of player check-ins at the one or more physical locations.

19. The apparatus of claim 13, wherein the instructions further cause the apparatus to present, on the electronic display device, the wagering game with the original wagering game content prior to replacing the original wagering game content.

20. One or more machine-readable storage media including instructions which, when executed by one or more processors, cause the one or more processors to perform operations comprising:
replace, by one or more processors, original wagering game content with modified wagering game content based on a wagering game player's check-in at a physical location, the physical location being associated with a business entity, the modified wagering game content being representative of and sponsored by the business entity; and
present, on an electronic display device, a wagering game with the modified wagering game content in place of the original wagering game content.

21. The one or more machine-readable storage media of claim 20, wherein the operation to present the wagering game comprise an operation to output a result of the wagering game, wherein the result includes an award of monetary value provided by the business entity.

22. The one or more machine-readable storage media of claim 20, wherein the wagering game comprises a slots game having reel symbols, wherein the operation to modify the wagering game content comprises an operation to replace at least one of the reel symbols with a modified reel symbol.

23. The one or more machine-readable storage media of claim 22, wherein operation to replace the at least one of the reel symbols with the modified reel symbol comprises operations to:
replace a first one of the reel symbols associated with a first payout value in response to a first number of check-ins by the wagering game player at the physical location; and
replace a second one of the reel symbols associated with a second payout value that is higher than the first payout value in response to a second number of check-ins by the wagering game player at the physical location, the second number of check-ins being greater than the first number of check-ins.

24. The one or more machine-readable storage media of claim 20, wherein prior to operations to replace, the one or more processors are configured to perform operations to present, on the electronic display device, the wagering game with the original wagering game content.

25. An apparatus comprising:
means for replacing, by one or more processors, original wagering game content with modified wagering game content based on a wagering game player's check-ins at one or more physical locations; and
means, includes an electronic display device, for presenting a wagering game with the modified wagering game content in place of the original wagering game content.

26. The apparatus of claim 25, wherein the modified wagering game content indicates the one or more physical locations.

27. The apparatus of claim 25, further comprising means for receiving, over a computer network, the modified wagering game content at a wagering game machine including the electronic display device

28. The apparatus of claim 25, wherein the physical location is associated with a business entity, and wherein a portion of the modified wagering game content is sponsored by the business entity.

29. The apparatus of claim 25, wherein the modified wagering game content varies based on a number of player check-ins at the one or more physical locations.

30. The apparatus of claim 25, further comprising, prior to the means for replacing, means for presenting, on the electronic display device, the wagering game with the original wagering game content.
